(19) United States
(12) Patent Application Publication
(10) Pub. No.: US 2020/0174147 A1
(43) Pub. Date: Jun. 4, 2020

(54) METHOD FOR SEISMIC DATA ACQUISITION AND PROCESSING

(71) Applicant: SEISMIC APPARITION GmbH, Pfäffikon SZ (CH)

(72) Inventors: Johan ROBERTSSON, Wald (CH); Robin Walker, Burgess Hill (GB); Fredrik Andersson, Altendorf (CH); Dirk-Jan Van Manen, Otelfingen (CH); Kurt Eggenberger, Schinznach (CH)

(73) Assignee: SEISMIC APPARITION GmbH, Pfäffikon SZ (CH)

(21) Appl. No.: 16/784,604

(22) Filed: Feb. 7, 2020

Related U.S. Application Data
(63) Continuation of application No. PCT/IB2018/055922, filed on Aug. 7, 2018.

(30) Foreign Application Priority Data
Aug. 10, 2017 (GB) 1712876.0
Jun. 7, 2018 (GB) 1809367.4

(51) Int. Cl. G01V 1/38; G01V 1/116; G01V 1/30

(52) U.S. Cl. CPC G01V 1/3808; G01V 1/3817; G01V 1/116; G01V 2210/20; G01V 2210/121; G01V 2210/127; G01V 2210/1293; G01V 1/301

(57) ABSTRACT

Methods are described for separating the unknown contributions of two or more sources from a commonly acquired set of wavefield signals representing a wavefield where the sources are laterally located relatively close to each other and fire relatively close in time, and where the contributions from different sources are separated using different source encoding techniques in different parts of a frequency band of interest.

This application is a continuation of PCT Application No. PCT/IB2018/055922, filed Aug. 7, 2018, which claims priority to Great Britain Application No. 1712876.0, filed Aug. 10, 2017, and Great Britain Application No. 1809367.4, filed Jun. 7, 2018. The entire contents of the above-identified applications are incorporated herein by reference

### FIELD

The present invention relates to methods for acquiring and partially combining contributions from two or more different simultaneously or near simultaneously emitting sources in a common set of measured signals representing a wavefield. In particular, the present invention relates to acquiring and partially combining (at lower frequencies) contributions from two or more physically closely located different simultaneously or nearly simultaneously emitting seismic sources with higher frequency contributions where the contributions from different sources are encoded by means of the simultaneous source methods such as, but not limited to, the method of signal apparition or methods using random dithering to encode sources. The invention would apply equally to onshore and offshore seismic surveys, and for implosive, explosive or vibratory type sources.

### BACKGROUND

Seismic data can be acquired in land, marine, seabed, transition zone and boreholes for instance. Depending on in what environment the seismic survey is taken place the survey equipment and acquisition practices will vary.

In towed marine seismic data acquisition a vessel tows streamers that contain seismic sensors (hydrophones and sometimes particle motion sensors). A seismic source usually but not necessarily towed by the same vessel excites acoustic energy in the water that reflects from the sub-surface and is recorded by the sensors in the streamers. The seismic source is typically an array of airguns customarily deployed as a set of sub-arrays, each of which includes a set of individual airguns. These are normally programmed to fire at the same instant, providing a close to instantaneous peak of energy followed by a longer, lower energy output as a result of oscillating air bubbles. A marine source can also be a marine vibrator for instance, which may be a single unit or a set of individual units composing an array. In either case, the intent is to provide a seismic source output which contains as far as possible a broad range of frequencies within the usable seismic frequency ranges, typically from 1-2 Hz up to around 500 Hz. In modern marine seismic operations many streamers are towed behind the vessel (3D seismic data acquisition). It is also common that several source and/or receiver vessels are involved in the same seismic survey in order to acquire data that is rich in offsets and azimuths between source and receiver locations.

In seabed seismic data acquisition, nodes or cables containing sensors (hydrophones and/or particle motion sensors) are deployed on the seafloor. These sensors can also record the waves on and below the seabottom and in particular shear waves which are not transmitted into the water. Similar sources are used as in towed marine seismic data acquisition. The sources are towed by one or several source vessels.

In land seismic data acquisition, the sensors on the ground are typically geophones and the sources are commonly vibroseis trucks. Vibroseis trucks are usually operated in arrays with two or more vibroseis trucks emitting energy close to each other roughly corresponding to the same shot location. In this invention we refer to such source configurations as groups of sources.

The general practice of marine and seabed seismic surveying is further described below in relation to FIG. 7.

Prospecting for subsurface hydrocarbon deposits (701) in a marine environment (FIG. 7) is routinely carried out using one or more vessels (702) towing seismic sources (703-705). The one or more vessels can also tow receivers or receivers (706-708) can be placed on the seabed (714).

Seismic sources typically employ a number of so-called airguns (709-711) which operate by repeatedly filling up a chamber in the gun with a volume of air using a compressor and releasing the compressed air at suitable chosen times (and depth) into the water column (712).

The sudden release of compressed air momentarily displaces the seawater, imparting its energy on it, setting up an impulsive pressure wave in the water column propagating away from the source at the speed of sound in water (with a typical value of around ˜1500 m/s) (713).

Upon incidence at the seafloor (or seabed) (714), the pressure wave is partially transmitted deeper into the subsurface as elastic waves of various types (715-717) and partially reflected upwards (718). The elastic wave energy propagating deeper into the subsurface partitions whenever discontinuities in subsurface material properties occur. The elastic waves in the subsurface are also subject to an elastic attenuation which reduces the amplitude of the waves depending on the number of cycles or wavelengths.

Some of the energy reflected upwards (720-721) is sensed and recorded by suitable receivers placed on the seabed (706-708), or towed behind one or more vessels. The receivers, depending on the type, sense and record a variety of quantities associated with the reflected energy, for example, one or more components of the particle displacement, velocity or acceleration vector (using geophones, mems [micro-electromechanical] or other devices, as is well known in the art), or the pressure variations (using hydrophones). The wave field recordings made by the receivers are stored locally in a memory device and/or transmitted over a network for storage and processing by one or more computers.

Waves emitted by the source in the upward direction also reflect downward from the sea surface (719), which acts as a nearly perfect mirror for acoustic waves.

One seismic source typically includes one or more airgun arrays (703-705): that is, multiple airgun elements (709-711) towed in, e.g., a linear configuration spaced apart several meters and at substantially the same depth, whose air is released (near-) simultaneously, typically to increase the amount of energy directed towards (and emitted into) the subsurface.

Seismic acquisition proceeds by the source vessel (702) sailing along many lines or trajectories (722) and releasing air from the airguns from one or more source arrays (also known as firing or shooting) once the vessel or arrays reach particular pre-determined positions along the line or trajectory (723-725), or, at fixed, pre-determined times or time intervals. In FIG. 7, the source vessel (702) is shown in three consecutive positions (723-725), also called shot positions.

Typically, subsurface reflected waves are recorded with the source vessel occupying and shooting hundreds of shots positions. A combination of many sail-lines (722) can form, for example, an areal grid of source positions with associated inline source spacings (726) and crossline source spacings. Receivers can be similarly laid out in one or more lines forming an areal configuration with associated inline receiver spacings (727) and crossline receiver spacings.

The general practice of land seismic surveying is further described below in relation to FIG. 8.

Prospecting for subsurface hydrocarbon deposits (801) in a land environment (FIG. 8) is routinely carried out using one or more groups of so-called seismic vibrators (802-805) or other sources such as shotpipes or dynamite (not shown). Seismic vibrators transform energy provided by, e.g., a diesel engine into a controlled sequence of vibrations that radiate away from the vibrator as elastic waves (806). More specifically, elastic waves emanate from a baseplate (807), connected to a movable element whose relative motion realizes the desired vibrations through a piston-reaction mass system driven by an electrohydraulic servo valve. The baseplate (807) is applied to the ground for each vibration, then raised up so that the seismic vibrator can drive to another vibrating point (indicated by solid markers such as triangles, circles, squares and pentagons in FIG. 8). To transmit maximum force into the ground and to prevent the baseplate from jumping, part of the weight of the vibrator is used to hold down the baseplate.

Thus, one group of seismic sources could consist of the “array” of vibrators 802 and 803, while a second group of sources consists, e.g., of vibrators 804 and 805.

The elastic waves radiating away from the baseplate of the vibrators scatter, reflect (808) and refract (809) at locations or interfaces in the subsurface where the relevant material properties (e.g., mass density, bulk modulus, shear modulus) vary and are recorded at hundreds of thousand of individual/single sensors (810) or at thousands of sensor groups (811). Sensor signals from one or more sensors in a group can be combined or summed in the field before being sent sent to the recording truck (812) over cables or wirelessly.

Source positions may lie along straight lines (814) or various other trajectories or grids. Similarly, receiver positions may lay along lines oriented in a similar direction as the source lines, e.g., 820, and/or oriented perpendicularly to the source lines (821). Receivers may also be laid out along other trajectories or grids. The source spacing along the line (815) is the distance the source in a group move between consecutive shotpoints. The inter source spacing (816) is the distance between two sources in the same source group. Similarly, the receiver spacing is the spacing between individual receivers (e.g., 818) in case single sensors or between sensor groups (e.g., 817). The source line spacing (819) is some representative distance between substantially parallel source lines and similarly for the receiver line spacing. Waves may be affected by perturbations in the near surface (813) which obscure the deeper structure of interest (i.e., possible hydrocarbon bearing formations). In land seismic data acquisition, the sensors on the ground are typically geophones.

Explosive sources may also be used onshore, which may be one large charge or a series of smaller ones.

Impulsive marine sources are traditionally formed from a combination of individual energy emitting source elements, typically being of the airgun type, by which a volume of compressed air is released into the water column to produce energy in the preferred frequency spectrum. Each airgun element is typically deployed a few metres below the surface, arranged into arrays of similar units.

There are various brand names and designs of such units, including but not limited to Sleeve Guns, GI Guns and Bolt Airguns and donut guns. All such units work in a similar way and will be referred to herein as “airgun” for the sake of convenience.

Each individual airgun unit has a specific volume of air, which can be configured by the user. As each unit is initiated, the air volume is ejected almost instantaneously into the water column, and the resulting bubble rises towards the surface, oscillating with a given periodicity with decaying amplitude. This continues for up to a second or two. The periodicity is a function of the volume and pressure of the air.

Individual airgun elements are combined into sub-arrays in various configurations, consisting of airguns with a range of volumes such that the bubble periodicity is different for each airgun element. Airgun units are commonly combined together in such sub-arrays such that the overall output consists of a short, aligned initial output (referred to as the “peak”), followed by a period in which the various bubble periodicity times result in largely destructive interference, in order to make the overall radiating pressure wave, referred to as the sub-array signature, as close as possible to the idealized spike. Such a process is referred to as sub-array tuning, and the techniques involved in this are well established practice and beyond the scope of this description.

Each airgun subarray is typically linear, though not universally so, and is usually deployed under some floatation device such that the in-line separation as well as the depth of the airgun elements is controlled and remains consistent at each shot point, resulting in as stable a signature as possible between each shot.

The output from a single sub-array—which typically consists of a dozen or fewer individual airguns—is generally considered to be insufficient for mainstream seismic exploration and reservoir management purposes. It is therefore common practice to use two or more sub-arrays, generally deployed laterally and/or in-line separated by a few (generally twenty or fewer) metres apart. This separation is user-designed and is aimed at controlling the extent to which the sub-array elements interact with each other.

The overall result is an array, consisting of two or more sub-arrays, each consisting of multiple airguns, usually of varying volumes such that they form a tuned array. The sub-arrays may be at the same or different depths, depending on the geophysical objectives. For example, some recent configurations may include a set of sub-arrays deployed at different depths, whose firing times may be staggered such that the down-going wavefront is uniform whilst the up-going wavefront exhibits destructive interference in order to reduce the so-called source ghost effect.

All of the units are generally (but not universally) excited such that the downgoing energy is created simultaneously, resulting in a far field signature where the peaks are all aligned.

Deficiency of low frequencies is generally a concern for seismic sources. In addition to the technique just described, sources are sometimes towed at greater depth to attempt enhancing the lower frequency content. However, towing a source at greater depth will introduce ghost notches within the spectrum of interest for higher frequencies. A composite approach to combine a deeper towed source for lower frequency with a sources towed shallower (i.e. a broadband source) is therefore of great interest.

After a short period of time, since the source vessel is moving continuously, a subsequent shot is fired after a few seconds. This is generally between five and twenty seconds for mainstream seismic acquisition. The objective, quite apart from giving time for the source vessel to move, is also to allow the energy from each shot-point to decay before the next one is initiated. Some approaches use shorter shot intervals (two or more seconds), often but not universally combined with some element of timing change on sequential shots in order to limit the impact of the insufficient decay time on sequential shot records. These approaches are referred to as “simultaneous source” and are discussed below. These approaches enable more source points per unit area, albeit at some compromise in terms of interference or fold.

An alternative approach to conventional simultaneous source separation is referred to as “Signal Apparition” (Robertsson et al., 2016) and discussed in more detail below by which shot points include sequences of individual shots, typically very closely separated in time (for example, each shot point is separated within a few tens of milliseconds, rather than a few seconds). Individual shots are then separated using the signal apparition approach which in theory is exact at low frequencies (although for certain and the most common choices of so-called modulation sequences discussed below the separation suffers from poor signal-to-noise ratio at low frequencies). The signal apparition approach is typically achieved with some variation of timing of shot sequences (but can also be achieved by other variations in shot sequences such as amplitude variations or source signature variations) and also will benefit from the use of some type of reconstruction technique to mitigate or limit aliasing at higher frequencies. There are no theoretical limitations on the number of shots that can be separated in this way.

In the following we will refer to all methods for simultaneous source acquisition and separation as well as methods for signal apparition-based source acquisition and separation and quasi-simultaneous source acquisition and separation as methods for simultaneous source acquisition and separation. Note that the source elements will not be fired at exactly the same time as some form of encoding (usually in time) is necessary. The descriptor simultaneous refers to sources that are being excited during the record time of another source.

In the description below we focus on sources towed by a single vessel. However, in principle the present invention also applies to sources towed by several vessels as long as the sources are in the proximity of each other (compared to the wavelength of interest for the low frequencies considered).

There are various practical limitations to the number of individual sub-arrays, and therefore, conventionally, arrays, that can be fired as part of any sequence from a single source vessel. These are summarized below:

Individual airgun unit cycle time. Each excitation and subsequent firing of any single airgun unit will necessitate the refilling of the compressed air chamber, and the re-charging of the capacitor used to power the solenoid which opens the compressed air port. This is typically a few seconds.

Total compressed air volume available per sub-array per unit time. The compressed air will have a maximum flow rate, which is a characteristic of the flow capacity of the high pressure air pipes (called umbilicals), which connect the airgun sub-array to the source vessel. This places a practical limit on the number of guns per subarray, though each sub-array typically has one or more umbilicals to connect it to the vessel and supply air.

Total compressed air volume available overall, per unit time. The compressors used to create the high volumes of high pressure (typically around 2,000 psi) have a limited capacity, and although there may be more than one, there is an eventual maximum (typically expressed as standard cubic feet per minute at the specified pressure) that can be delivered.

Total number of sub-arrays that can be deployed from the source vessel. For a large combined source and streamer towing vessel, this may be up to twelve sub-arrays, but for a smaller source-only vessel this may be as few as six or even three or four (in the case of a temporarily equipped source vessel).

Which of the above becomes the practical limitation to the total number of sub-arrays that may be deployed and used per shot-point in traditional approaches will depend on the attributes of the source design and the specific vessel being used. However, total compressor capacity and total number of sub-arrays are the more common.

Simultaneous source techniques are generally limited to the total number of sources available being the total number of sub-arrays divided by the number of sub-arrays required per source, for example, a nine-subarray equipped vessel would only be able to deploy three sources if each were three sub-arrays although some newer approaches re-use some sub-arrays in subsequent shot-points (e.g., Hager, 2016). Some examples of such configurations are summarized below:

For a six sub-array source vessel, the typical options include: two source, each with three sub-arrays (sub-arrays 1,2 and 3 followed by 4, 5 and 6); three sources each with two sub-arrays per source (sub-arrays 1 and 2, 3 and 4, then 5 and 6), or possible four sources, where some sub-arrays are re-used (for example, sub-arrays 1 and 3, then 2 and 4, then 3 and 5, then 4 and 6, for illustration).

The detailed design of the invention as described below works within these practical constraints.

In reality, the energy needed for many relatively shallow sub-surface targets is within the energy produced by a single sub-array, which may have a typical energy output of 15-20 Bar-metres. However, it is preferable to be able to illuminate deeper horizons, and for these, a greater energy output is usually considered to be necessary.

However, these deeper horizons are usually lower frequency, simply because the earth acts as a high frequency filter and only the lower frequencies (typically from 2-3 up to 20-30Hz or less) survive the two-way journey down to the deep reflecting horizon and back again to surface. During seismic data processing, band-pass filters are applied to the data to remove the higher frequencies, as these are often polluted by noise and contain little usable signal.

It therefore follows that the higher amplitudes are only necessary at lower frequencies. Airguns tend to produce a spectrum which contains all usable frequencies, however, of which the fullest bandwidth (up to highest) frequencies only return from shallower horizons (where the level of energy produced is often un-necessarily high).

Traditionally seismic data have been acquired sequentially: an impulsive source, typically formed of two or more airgun sub-arrays or vibroseis units is excited and data are recorded until the energy that comes back has diminished to an acceptable level and all reflections of interest have been captured after which a new shot at a different shot location is excited. Being able to acquire data from several sources at the same time is clearly highly desirable. Not only would it allow to cut expensive acquisition time drastically but it could also better sample the wavefield on the source side which typically is much sparser sampled than the distribution of receiver positions. It would also allow for better illumination of the target from a wide range of azimuths as well as to better sample the wavefield in areas with surface obstructions. In addition, for some applications such as 3D VSP acquisition, or marine seismic surveying in environmentally sensitive areas, reducing the duration of the survey is critical to save costs external to the seismic acquisition itself (e.g., down-time of a producing well) or minimize the impact on marine life (e.g., avoiding mating or spawning seasons of fish species).

Seismic energy produced by a source of whatever type reflects from the various layers in the sub-surface and is captured by the sensors, be they streamer mounted, sea floor or onshore. A typical seismic source consists of multiple sub-arrays (in the case of implosive sources such as marine airguns) or vibrator units. These elements are separated by a certain distance (up to a few tens of metres) for practical reasons, however they are excited simultaneously and behave as a single point-like source provided that the dimensions of the source is smaller than the wavelength of interest (e.g., at 120 Hz the wavelength in water is 12.5 m. A typical source conventional array used for such applications can have three subarrays spaced 6 m apart, e.g., a total size of 12 m). In conventional sequential seismic acquisition, the whole energy frequency spectrum associated with a specific individual shot is usually derived from the whole set of source sub-arrays or elements used in that shot.

In conventional seismic acquisition, as well as in all time-encoded, space-encoded, or time and space encoded techniques as summarized above, the objective is to treat each (if necessary, deblended) output shot record as a separate shot. To this end, it is normal for each actual input shot to include not only the full frequency range but also the full required output energy level. To this end, as noted, it is common practice in terms of airgun sources to use three sub-arrays of airguns, each typically located 5-20 metres from each other in a cross-line sense, in order to minimise interference between each subarray. Typical peak energy output from a three sub-array source may be in the order of around 40 bar-m or more (e.g. Landroe et al., 2011), whereas the output of a single sub-array is around 15-20 bar-m. The multiple sub-array approach is used as the energy output of a single sub-array is considered insufficient, in particular for deeper reflection points, which exhibit, as discussed above, primarily a low frequency response. Under certain circumstances, three sub-arrays is considered insufficient to provide the level of energy required for such deep reflections and under these circumstances a four sub-array source is required.

There are several practical constraints on the maximum number of sub-arrays that can be fired at any individual shot, including if that shot is part of a time encoded technique. These include the maximum number of sub-arrays that are available for deployment from the source vessel—which is often limited to six or eight; the maximum total volume of high pressure air that can be supplied in a given time (the typical reference time cycle is around 10 seconds) and the distance travelled by the source vessel in the time between individual shots. In addition, there are constraints on the time required to fill the larger individual airgun chambers. For marine vibratory-type sources the typical deployment challenges are linked to the space available on the vessel for storage, the total drag of the individual vibrator elements and the total energy available (usually either electric or hydraulic) in order to power the units. For land (onshore) vibrator sources, the limit is more related to total cost for equipment, each vibratory unit being expensive to buy and operate.

Simultaneously emitting sources, such that their signals overlap in the (seismic) record, is also known in the industry as “blending”. Conversely, separating signals from two or more simultaneously emitting sources is also known as “deblending” and the data from such acquisitions as “blended data”.

Simultaneous source acquisition has a long history in land seismic acquisition dating back at least to the early 1980's. Commonly used seismic sources in land acquisition are vibroseis sources which offer the possibility to design source signal sweeps such that it is possible to illuminate the sub-surface “sharing” the use of certain frequency bands to avoid simultaneous interference at a given time from different sources. By carefully choosing source sweep functions, activation times and locations of different vibroseis sources, it is to a large degree possible to mitigate interference between sources. Such approaches are often referred to as slip sweep acquisition techniques. In marine seismic data contexts the term overlapping shooting times is often used for related practices. Moreover, it is also possible to design sweeps that are mutually orthogonal to each other (in time) such that the response from different sources can be isolated after acquisition through simple cross-correlation procedures with sweep signals from individual sources. We refer to all of these methods and related methods to as “time encoded simultaneous source acquisition” methods and “time encoded simultaneous source separation” methods.

The use of simultaneous source acquisition in marine seismic applications is more recent as marine seismic sources (i.e., airgun sources) do not appear to yield the same benefits of providing orthogonal properties as land seismic vibroseis sources, at least not at a first glance. Western Geophysical was among the early proponents of simultaneous source marine seismic acquisition suggesting to carry out the separation as a pre-processing step by assuming that the reflections caused by the interfering sources have different characteristics. Beasley et al. (1998) exploited the fact that provided that the sub-surface structure is approximately layered, a simple simultaneous source separation scheme can be achieved for instance by having one source vessel behind the spread acquiring data simultaneously with the source towed by the streamer vessel in front of the spread. Simultaneous source data recorded in such a fashion is straightforward to separate after a frequency-wavenumber (ωk) transform as the source in front of the spread generates data with positive wavenumbers only whereas the source behind the spread generates data with negative wavenumbers only.

Another method for enabling or enhancing separability is to make the delay times between interfering sources incoherent (Lynn et al., 1987). Since the shot time is known for each source, they can be lined up coherently for a specific source in for instance a common receiver gather or a common offset gather. In such a gather all arrivals from all other simultaneously firing sources will appear incoherent. To a first approximation it may be sufficient to just process the data for such a shot gather to final image relying on the processing chain to attenuate the random interference from the simultaneous sources (aka. passive separation). However, it is of course possible to achieve better results for instance through random noise attenuation or more sophisticated methods to separate the coherent signal from the apparently incoherent signal (Stefani et al., 2007; Ikelle 2010; Kumar et al. 2015). In recent years, with elaborate acquisition schemes to for instance acquire wide azimuth data with multiple source and receiver vessels (Moldoveanu et al., 2008), several methods for simultaneous source separation of such data have been described, for example methods that separate “random dithered sources” through inversion exploiting the sparse nature of seismic data in the time-domain (i.e., seismic traces can be thought of as a subset of discrete reflections with “quiet periods” in between; e.g., Akerberg et al., 2008; Kumar et al. 2015). A recent state-of-the-art land example of simultaneous source separation applied to reservoir characterization is presented by Shipilova et al. (2016). Existing simultaneous source acquisition and separation methods based on similar principles include quasi random shooting times, and pseudo random shooting times. We refer to all of these methods and related methods to as “random dithered source acquisition” methods and “random dithered source separation” methods. “Random dithered source acquisition” methods and “random dithered source separation” methods are examples of “space encoded simultaneous source acquisition” methods and “space encoded simultaneous source separation” methods.

A different approach to simultaneous source separation has been to modify the source signature emitted by airgun sources. Airgun sources comprise multiple (typically three) sub-arrays each comprised of several individual airguns or clusters of smaller airguns. Whereas in contrast to land vibroseis sources, it is not possible to design arbitrary source signatures for marine airgun sources, one in principle has the ability to choose firing time (and amplitude i.e., volume) of individual airgun elements within the array. In such a fashion it is possible to choose source signatures that are dispersed as opposed to focused in a single peak. Such approaches have been proposed to reduce the environmental impact in the past (Ziolkowski, 1987) but also for simultaneous source shooting.

Abma et al. (2015) suggested to use a library of “popcorn” source sequences to encode multiple airgun sources such that the responses can be separated after simultaneous source acquisition by correlation with the corresponding source signatures following a practice that is similar to land simultaneous source acquisition. The principle is based on the fact that the cross-correlation between two (infinite) random sequences is zero whereas the autocorrelation is a spike. It is also possible to choose binary encoding sequences with better or optimal orthogonality properties such as Kasami sequences to encode marine airgun arrays (Robertsson et al., 2012). Mueller et al. (2015) propose to use a combination of random dithers from shot to shot with deterministically encoded source sequences at each shot point. Similar to the methods described above for land seismic acquisition we refer to all of these methods and related methods to as “time encoded simultaneous source acquisition” methods and “time encoded simultaneous source separation” methods.

Yet another approach is to fire a sequence of source arrays, one or more of which has a random time dither applied relative to the adjacent source points, but at a shorter time interval, for example, five seconds rather than the conventional ten. This has the advantage of keeping the shallow part of each shot free from interference, whilst mitigating the drop in fold. For example, conventional exploration seismic involves two identical source arrays, offset laterally from each other by, for example, 50 m (source centre to source centre). The firing cycle is Port-starboard-port-starboard, such that a source fires every ten seconds, into different sub-surface lines. This results in half-fold data relative to single source. Experiments with triple source using the same approach resulted in ⅓ fold data, considered insufficient. The partially overlapping approach in the above dual source example, would involve firing every 5 seconds, returning to full fold. Employing the same approach with three partially overlapping sources and a five second shot interval would result in limited fold drop and undisturbed shallow data. However, extrapolating this form three to four sources, for example (and temporarily ignoring the issues outlined above about overall sub-array capacity) would require, for example, a 2-3 second shot interval, resulting in limited undisturbed data lengths and loss of fold. Taking into consideration the practicalities, it has also been presented (for example, Hager, 2016), to arrange the firing sequence such that individual airgun sub-arrays may form part of more than one array, as noted above. However, the interference of adjacent shots (even mitigated by dither) and the loss of fold are unavoidable and their effects increase as attempts are made to increase the total number of arrays.

Recently there has been an interest in industry to explore the feasibility of marine vibrator sources as they would, for instance, appear to provide more degrees of freedom to optimize mutually orthogonal source functions beyond just binary orthogonal sequences that would allow for a step change in simultaneous source separation of marine seismic data. Halliday et al. (2014) suggest to shift energy in ωk-space using the well-known Fourier shift theorem in space to separate the response from multiple marine vibrator sources. Such an approach is not possible with most other seismic source technology (e.g., marine airgun sources) which lack the ability to carefully control the phase of the source signature (e.g., flip polarity).

The recent development of “signal apparition” suggests an alternative approach to deterministic simultaneous source acquisition that belongs in the family of “space encoded simultaneous source acquisition” methods and “space encoded simultaneous source separation” methods. Robertsson et al. (2016) show that by using modulation functions from shot to shot (e.g., a short time delay or an amplitude variation from shot to shot), the recorded data on a common receiver gather or a common offset gather will be deterministically mapped onto known parts of for instance the ωk-space outside the conventional “signal cone” where conventional data is strictly located (FIG. 1, part (A)). The signal cone contains all propagating seismic energy with apparent velocities between water velocity (straight lines with apparent slowness of +−1/1500 s/m in ωk -space) for the towed marine seismic case and infinite velocity (i.e., vertically arriving events plotting on a vertical line with wavenumber 0). The shot modulation generates multiple new signal cones that are offset along the wavenumber axis thereby populating the ωk-space much better and enabling exact simultaneous source separation below a certain frequency (FIG. 1, part (B)). Robertsson et al. (2016) referred to the process as “signal apparition” in the meaning of “the act of becoming visible”. In the spectral domain, the wavefield caused by the periodic source sequence is nearly “ghostly apparent” and isolated. A critical observation and insight in the “signal apparition” approach is that partially shifting energy along the ωk-axis is sufficient as long as the source variations are known as the shifted energy fully predicts the energy that was left behind in the “conventional” signal cone. Following this methodology simultaneously emitting sources can be exactly separated using a modulation scheme where for instance amplitudes and or firing times are varied deterministically from shot to shot in a periodic pattern.

Consider a seismic experiment where a source is excited sequentially for multiple source locations along a line while recording the reflected wavefield on at least one receiver. The source may be characterized by its temporal signature. In the conventional way of acquiring signals representing a wavefield the source may be excited using the same signature from source location to source location, denoted by integer n. Next, consider the alternative way of acquiring such a line of data using a periodic sequence of source signatures: every second source may have a constant signature and every other second source may have a signature which can for example be a scaled or filtered function of the first source signature. Let this scaling or convolution filter be denoted by a(t), with frequency-domain transform A(ω). Analyzed in the frequency domain, using for example a receiver gather (one receiver station measuring the response from a sequence of sources) recorded in this way, can be constructed from the following modulating function m(n) applied to a conventionally sampled and recorded set of wavefield signals:

m(n)=½[1+(−1)ⁿ]+½A[1−(−1)ⁿ],

which can also be written as

m(n)=½[1+e^{iπn}]+½A[1−e^{iπn}]. (0.1)

By applying the function m in Eq. 0.1 as a modulating function to data ƒ(n) before taking a discrete Fourier transform in space (over n), F(k)= [symbol] (ƒ(n)), the following result can be obtained:

$$ℱ ( f ( n ) m ( n ) ) = \frac{1 + A}{2} F ( k ) + \frac{1 - A}{2} F ( k - {k}_{N} ) , \qquad ( 0.2 )$$

which follows from a standard Fourier transform result (wavenumber shift) (Bracewell, 1999).

Eq. 0.2 shows that the recorded data ƒ will be scaled and replicated into two places in the spectral domain as illustrated in FIG. 1(B) and as quantified in Tab. I for different choices of A(ω).

| A(ω) | H₋ = (1 − A)/2 | H₊ = (1 + A)/2 |
|---|---|---|
| 1 | 0 | 1 |
| −1 | 1 | 0 |
| 0 | ½ | ½ |
| ½ | ¼ | ¾ |
| e^{iωT} | (1 − e^{iωT})/2 | (1 + e^{iωT})/2 |
| 1 + e^{iωT} | −e^{iωT}/2 | 1 + e^{iωT}/2 |

TAB. I. Mapping of signal to cone centered at k=0 (H₊) and cone centered at k=k_{N} (H₋) for different choices of A(ω) for signal separation or signal apparition in Eq. (0.2).

Part of the data will remain at the signal cone centered around k=0 (denoted by H₊ in FIG. 1(b)) and part of the data will be scaled and replicated to a signal cone centered around k_{N} (denoted by H₋). It can be observed that by only knowing one of these parts of the data it is possible to predict the other.

This process may be referred to as, “signal apparition” in the meaning of “the act of becoming visible”. In the spectral domain, the wavefield caused by the periodic source sequence is nearly “ghostly apparent” and isolated.

A particular application of interest that can be solved by using the result in Eq. (0.2) is that of simultaneous source separation. Assume that a first source with constant signature is moved along an essentially straight line with uniform sampling of the source locations where it generates the wavefield g. Along another essentially straight line a second source is also moved with uniform sampling. Its signature is varied for every second source location according to the deterministic modulating sequence m(n), generating the wavefield h. The summed, interfering data ƒ=g+h are recorded at a receiver location.

In the frequency-wavenumber domain, where the recorded data are denoted by F=G+H, the H-part is partitioned into two components H₊ and H₋ with H=H₊+H₋ where the H₋-component is nearly “ghostly apparent” and isolated around the Nyquist-wavenumber [FIG. 1(B)], whereas G and H₊ are overlapping wavefields around k=0. Furthermore, H₋ is a known, scaled function of H. The scaling depends on the chosen A(ω) function (Tab. I), and can be deterministically removed, thereby producing the full appearance of the transformed wavefield H. When H is found, then G=F−H yielding the separate wavefields g and h in the time-space domain.

Although the above description has focused on acquisition along essentially straight lines, the methodology applies equally well to curved trajectories such as coil-shaped trajectories, circles, or other smoothly varying trajectories or sequences of source activations.

The concept may be extended to the simultaneous acquisition of more than two source lines by choosing different modulation functions for each source.

Acquiring a source line where the first two source locations have the same signature, followed by two again with the same signature but modified from the previous two by the function A(ω) and then repeating the pattern again until the full source line has been acquired, will generate additional signal cones centered around ±k_{N}/2.

FIG. 1(B) also illustrates a possible limitation of signal apparition. The H₊ and H₋ parts are separated within the respective lozenge-shaped regions in FIG. 1(B). In the triangle-shaped parts they interfere and may no longer be separately predicted without further assumptions. In the example shown in FIG. 1(B), it can therefore be noted that the maximum non-aliased frequency for a certain spatial sampling is reduced by a factor of two after applying signal apparition. Assuming that data are adequately sampled, the method nevertheless enables full separation of data recorded in wavefield experimentation where two source lines are acquired simultaneously.

As is evident from Tab. I, the special case A=1 corresponds to regular acquisition and thus produces no signal apparition. Obviously, it is advantageous to choose A significantly different from unity so that signal apparition becomes significant and above noise levels. The case where A=−1 (acquisition of data where the source signature flips polarity between source locations) may appear to be the optimal choice as it fully shifts all energy from k=0 to k_{N} (Bracewell, 1999). Although this is a valid choice for modeling, it is not practical for many applications (e.g., for marine air gun sources, see Robertsson et al., 2015 as it requires the ability to flip polarity of the source signal. The case where A=0 (source excited every second time only) may be a straightforward way to acquire simultaneous source data but has the limitation of reduced sub-surface illumination. A particularly attractive choice of A(ω) for wave experimentation seems to let every second source be excited a time shift T later compared to neighbouring recordings, that is, select A=e^{iωT}.

In the prior art it has been suggested to combine different methods for simultaneous source acquisition. Müller et al. (2015) outline a method based on seismic data acquisition using airgun sources. By letting individual airguns within a source airgun array be actuated at different time a source signature can be designed that is orthogonal to another source signature generated in a similar fashion. By orthogonal, Müller et al. (2015) refer to the fact that the source signatures have well-behaved spike-like autocorrelation properties as well as low cross-correlation properties with regard to the other source signatures used. On top of the encoding in time using orthogonal source signatures, Müller et al. (2015) also employ conventional random dithering (Lynn et al., 1987). In this way, two different simultaneous source separation approaches are combined to result in an even better simultaneous source separation result.

Halliday et al. (2014) describe a method for simultaneous source separation using marine vibrator sources that relies on excellent phase control in marine vibrator sources to fully shift energy along the wavenumber axis in the frequency-wavenumber plane.

For time-dithered simultaneous source acquisition Abma et al. (2012) and Jiang and Abma (2010), report that the very low frequencies are compromised when using short time dithers. To overcome this limitation, they suggest to resort to a large dither length of several hundred milliseconds and more rendering particularly single-vessel multi-source acquisition impractical.

Signal apparition technology, however, does in principle not suffer from this apparent drawback. However, there is a separate issue that needs to be considered with respect to the low frequency response for a particular choice of modulation function that is particularly attractive to use for practical reasons.

For many choices of the factor A governing the modulation sequence, low frequencies can be separated just as well as higher frequencies (see Table I). However, a particularly attractive choice for the factor is A=e^{iωT} which amounts to a time shift. Typically a small time shift is chosen so that ωT<π for sufficiently high frequencies to avoid nulls (notches) within the frequency band of interest. However, for sufficiently low frequencies we then observe the same problem as well with a notch at DC where ωT is small (close to 0). From inspecting Table I we see that in the limit no energy is shifted to the cone centered at the Nyquist wavenumber. Instead all energy for all sources remain overlapping in the cone at zero wavenumber.

It is herein proposed to use hybrid methods for simultaneous source separation where conventional methods for simultaneous source separation or the method of signal apparition or combinations therefor are used in intermediate to high frequency bands of interest whereas a different approach is used for the very low frequency band of interest where the method for source separation does not work as well as for higher frequencies (e.g., due to the inability to exactly control firing times) or that generally enhance the separation result.

### SUMMARY

Methods for employing the mid- and far-field constructive interference effect of low frequency energy in multiple simultaneous or near-simultaneous source points in the vicinity of each other such that the deep penetrating lower frequencies are combined together but where the higher frequencies are subsequently separated in some way, including (but not necessarily) by means of the signal apparition approach mentioned above or a conventional method for simultaneous source separation such as methods based on random dithering substantially as shown in and/or described in connection with at least one of the figures, and as set forth more completely in the claims.

Advantages, aspects and novel features of the present invention, as well as details of an illustrated embodiment thereof, may be more fully understood from the following description and drawings.

### BRIEF DESCRIPTION OF THE DRAWINGS

In the following description reference is made to the attached figures, in which:

FIG. 1 illustrates how in a conventional marine seismic survey all signal energy of sources typically sits inside a “signal cone” bounded by the propagation velocity of the recording medium and how this energy can be split in a transform domain by applying a modulation to a second source;

FIG. 2 shows a synthetic example embodiment of the invention, where two sources are fired simultaneously in a survey (Source A and B) being recorded at a receiver. At location of Source C a reference data set is available to compare with the combined response of Sources A and B, and their separated responses;

FIG. 3 shows the responses due to Sources A and B if they would have been generated separately (reference solutions after the separation of the simultaneous source experiment);

FIG. 4 shows the simultaneous source response of Source A and B as well as the single source response at the reference position in between (Source C);

FIG. 5 shows the 10 Hz high cut filtered reference data for Sources A and B;

FIG. 6 shows the 10 Hz high cut filtered and source signature corrected simultaneous source response of Source A and B as well as the 10 Hz high cut filtered single source response at the reference position in between (Source C);

FIG. 7 shows the general practice of marine seismic surveying;

FIG. 8 shows the general practice of land seismic surveying;

FIG. 9 summarizes key steps for one embodiment of the methods disclosed herein; and

FIG. 10 illustrates how the methods herein may be computer-implemented;

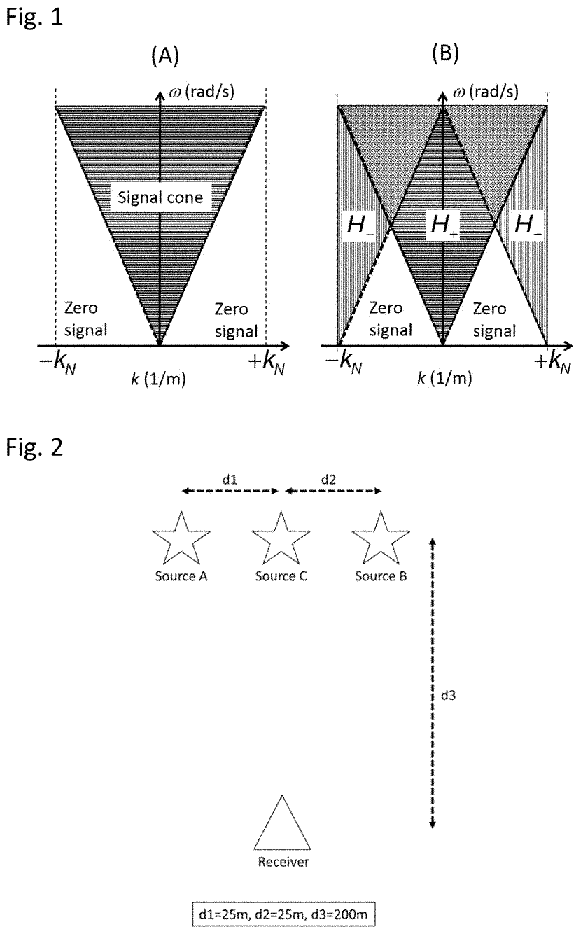

### DETAILED DESCRIPTION

The following examples may be better understood using a theoretical overview as presented below.

It is herein proposed to use the fact that multiple isolated sources shot using either the signal apparition approach (Robertsson, 2016), or indeed any other approach wherein the sources are fired in close temporal and/or physical separation, are treated as a master shot with a sequence of subsidiary shots all fired in close temporal proximity. For example, if each separate source fires in a time sequence approximately 10 milliseconds apart, then even if five such sources are fired as a sequence and subsequently isolated, the total time from first to last firing would be around 40 milliseconds.

It is advantageous to choose a firing sequence such that all sources fire within half a period of the upper end of the low frequency band that we wish to construct using the present invention. Therefore, if this upper limit is as low as 6 Hz, then the sources should all fire within 80 ms.

It is also herein proposed to acquire simultaneous source data where all sources are located in vicinity of each other such that the size of the effective source array of the master shot is comparable to the wavelength of interest for the low frequencies to be reconstructed. For example, typical conventional source arrays may have a dimension of 15 m between the outer sub arrays. Such an arrangement is considered to be sufficient to have point source like data up to say 120 Hz. A similar argument would then apply to reconstructing frequencies up to 12 Hz for sources spaced 150 m apart. In other words, the master shot may contain sources spaced as far apart as 150 m if we wish to reconstruct data up to 12 Hz using the present invention. Similarly, the master shot may contain sources spaced as far apart as 300 m if we wish to reconstruct data up to 6 Hz using the present invention.

Such arrangement of sources can be towed by a single vessel or if one desires my multiple vessels in the vicinity of each other.

One attribute of signal apparition is that at low frequencies, the signal cones in f-k space largely overlap. This feature can thus be exploited in this invention such that the low frequencies (typically 10 Hz or below) from any of the sources can be treated as energy contributing to all sources. However, for higher frequencies, where the signal cones in f-k space do not overlap, each input source can thus be separated. Since the higher frequencies tend to come primarily from shallower reflectors in the sub-surface, the energy output of a single or dual vibrator or airgun sub-array will in most cases be sufficient to provide the requisite signal-to-noise ratio, whereas the lower frequencies from all source elements can be treated as a composite (and therefore higher energy) output source, suitable for the deeper reflectors (and the lower frequency components of all depths).

Within the typical spatial separation of the sources (as an example, 50 m lateral separation between sources is quite common, though the approach would work at all achievable separations), as well as the typical temporal separation as noted above, the low frequencies (as an example, up to 10 or 15 Hz) would be largely constructive in impact, whilst their exact contribution would also be known. The effect would thus be to be able to use the constructive interference effect of the low frequency contributions from all of the individual source elements (land or marine vibrators or airgun sub-array sets) in the shot sequence to generate the overall low frequency energy required to ensure return from deep sub-surface reflections (but well within the spatial or temporal positive contribution Fresnel zone) whilst providing the specific isolated energy from the higher frequency energy from each of the contributing land or marine vibrators or sub-array sets to each isolated shot.

Source characteristics (individual element timing and/or near-field measurements) are often used for producing a far-field source signature. These approaches will ensure that the signature for the source sequence overall (corresponding to the “master shot”) would be known and could therefore be taken into consideration during processing to yield an excellent low-frequency response where the small timing differences have been deconvolved from the recorded low frequency data.

We note that in order to provide a good low frequency response it will be beneficial for all source elements to fire within a short time that is small compared to the period of the low frequency energy of interest. For example, if we are considering 10 Hz data or lower, the period of these data is 100 ms or greater. Making sure that all source elements fire at their respective source separation encoded timings within say 30 ms will ensure an overall good source signature for the low frequencies with good signal-to-noise in the recorded data.

Although the low frequency response will only vary slowly laterally with respect to shot points (due to the longer wavelengths of emitted and recorded data), the effective shot point associated with the low frequency response from the “master shot” comprising several sources within a larger area, should be associated with the average lateral location. For example, if two sources of similar characteristics are used during simultaneous source acquisition, the low frequency response obtained by the present invention should be allocated to a shot point that lies in between the two source locations. In an additional optional step, it is therefore proposed to regularize the low-frequency responses which are not associated with the same shot points as the intermediate to high frequency separated source data. The regularization should preferably be applied in the 2D horizontal plane so that the low frequency response can be reconstructed to the correct locations also in the cross-line direction (e.g., including many parallel sail lines). This process can be carried out using any known method for spatial regularization and is not expected to be particularly difficult as the low frequencies are spatially well sampled due to their longer wavelengths.

The regularization algorithm can also involve a modeling step where the averaging process of the generated response due to the simultaneously firing sources is included for instance through a Fourier representation in terms of modelling and regularization. This will further improve the accuracy and quality of the regularization allowing for somewhat greater separation of sail lines.

Following the deconvolution of the effective source signature and a convolution with a desired source signature consistent with the source signature of the higher frequencies and/or regularization of a low frequency response at all shot locations where the intermediate to high frequencies have been separated by other means (e.g., signal apparition or random dithering), the two data sets (low and intermediate/high frequencies) can now be combined into a full bandwidth data set at all the desired shot point locations.

The proposed approach would in all cases result in fewer vibrators or sub-arrays being required per source point compared with conventional or time encapsulated techniques, whilst simultaneously increasing the total used energy per shot sequence. This in turn would result in an increase in the total used energy per square kilometre of survey area whilst reducing the instantaneous peak output.

In another embodiment of the present invention we carry out the simultaneous source separation for the entire bandwidth including the low frequencies. As an example, the method of signal apparition (Robertsson et al., 2016) allows for exact simultaneous source separation given sufficient sampling along the direction of spatial encoding (there is always a lowest frequency below which source separation in theory is exact). It is the only exact method there exists for conventional marine and land seismic sources such as airgun sources and dynamite sources.

Signal apparition is also a method that is particularly suitable to separate the response from two sources that are close to each other. The effect of signal apparition is to map source contributions into opposite locations of the frequency wavenumber space thus making their subsurface response appear as different from each other as possible even if the two sources are excited at nearby locations.

A particularly interesting acquisition configuration will therefore include sources that are close to each other (towed by the same vessel for example 25 m or 50 m apart from each other). Clearly, the response from the signal generated by two sources close to each other and recorded on common receiver will be similar but not identical. In addition, we are interested in using small time shifts (for instance 10 ms or 20 ms) and a modulation function with select A=e^{iωT}. For low frequencies the difference in the emitted source signature from shot point to shot point will be very small as the time shift is small compared to the period of the frequency of interest at low frequencies (e.g., below say 5 Hz or 10 Hz if we consider a time shift of say 10 ms or 20 ms).

Equation (0.2) gives some insight into what happens at the very low frequencies. At low frequencies (i.e., below 10 Hz or 5 Hz), almost all energy will remain within the cone centered at 0 wavenumber (where the average of the signal due to the two sources is mapped) and very little energy will be mapped to the cone centered at the Nyquist wavenumber (where the difference of the signal due to the two sources is mapped). This is a consequence of the fact that the response due to the two source looks very similar at low frequencies for two reasons. First, the sources are close to each other and for low frequencies in particular the response will be very similar. Secondly, the modulation function will not introduce a significant variation from shot point to shot point for low frequencies if the time-shift is small.

In the general case, Andersson et al. (2016) shows how the data in the two cones will correspond to the average of the sources in the cone centred at zero wavenumber and the difference between the two sources at the Nyquist wavenumber (by setting a₀(ω)=a₁(ω)=1 in their equation 6).

In this embodiment of the invention where the same source separation is carried out through the entire bandwidth the deconvolution step to correct for source signatures should not be carried out as this is already implicitly carried out in the separation process. However, as described above, the separated quantity is associated with the average of the response of the simultaneous sources for low frequencies and a lateral spatial regularization step to associate the low frequency response exactly with desired shot locations may be carried out. After this optional step the two data sets (low and intermediate/high frequencies) can now be combined into a full bandwidth data set at all the desired shot point locations.

In another embodiment of the invention, the spatial separation of the sources and the relative activation time of all sources are chosen to ensure a signal-to-noise ratio that will be close to the signal-to-noise ratio of a survey where all sources would have been fired at the same time and the same location. Within this spatial separation and within that relative activation time the separate sources will appear as one single source for practical purposes. The design of a survey along these criteria is obvious from the above by for instance requiring that all sources should be located within half a wavelength or less from each other and activated within half a period or less from each other to ensure constructive interference of the emitted signals below the lowest frequency corresponding to the half wavelength of separation in space and half a period of separation in time. Survey design could begin with choosing the frequency for which the above conditions should be satisfied. The choice of the frequency may depend on a number of different parameters including the desired resolution, the depth to the reservoir, the need for stable inversion, etc.

### Example

A synthetic example was created using an acoustic 3D finite-difference synthetic data set mimicking a seabed seismic acquisition geometry over a complex sub surfaced model. For simplicity the example is limited to the effect for a single simultaneous source shot being recorded on a receiver. A more complete example would have encompassed an entire grid of shots to carry out the simultaneous source separation at the higher part of the frequency band of interest and to enable regularization in a plane for source positions for the low frequency part of the frequency band of interest as described above.

FIG. 2 shows a schematic view of the example. We consider here a simultaneous source experiment with two sources denoted Source A and Source B (A similar example could also have been created for a larger number of sources firing simultaneously).

FIG. 2 also shows the location of a virtual reference Source position referred to as Source C which in the case of two simultaneous sources is located right in between Sources A and Source B.

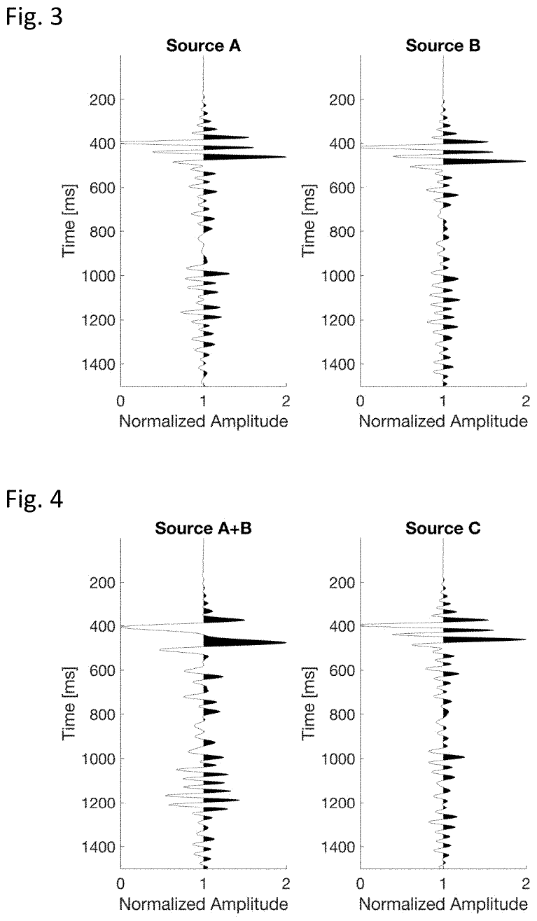

FIG. 3 shows the reference responses due to Source A and Source B separately as if the separation of the combined sources would have been perfect throughout the entire frequency band. The responses from Sources A and B is different as they illuminate the subsurface differently due to their different source locations. In addition we have included a small timeshift of 20 ms between the firing times to represent the encoding that would have been carried out from shot point to shot point (e.g., due to the modulation sequence in the method of signal apparition as described above).

FIG. 4 shows the simultaneous source response of Source A and B (i.e. the data that would have been acquired before separation) as well as the response at the reference position Source C. We note that there are quite some differences between the simultaneous source response (Source A+B) and the response at the reference position in between. Again, this is a result of both the different illumination of the subsurface as well as the time shift between the two sources due to the source encoding from shot point to shot point.

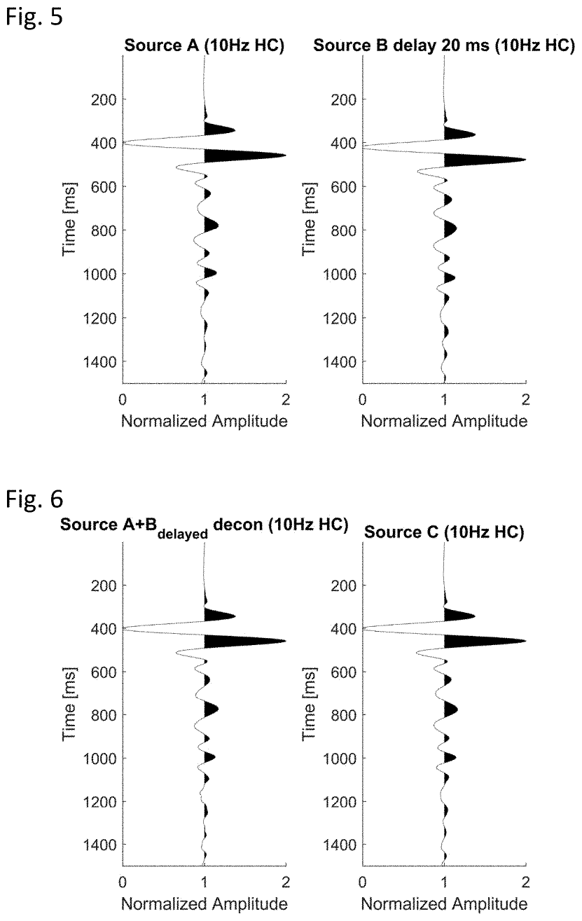

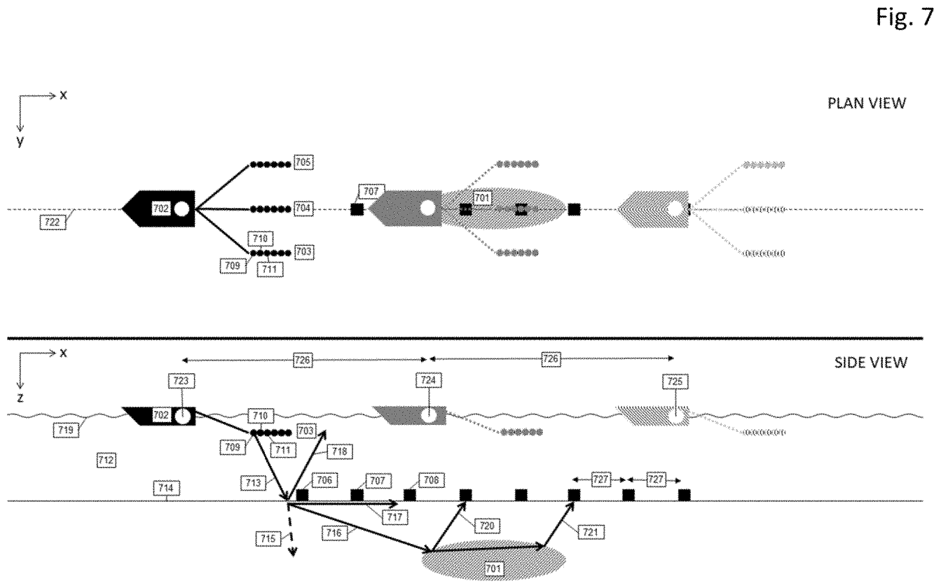

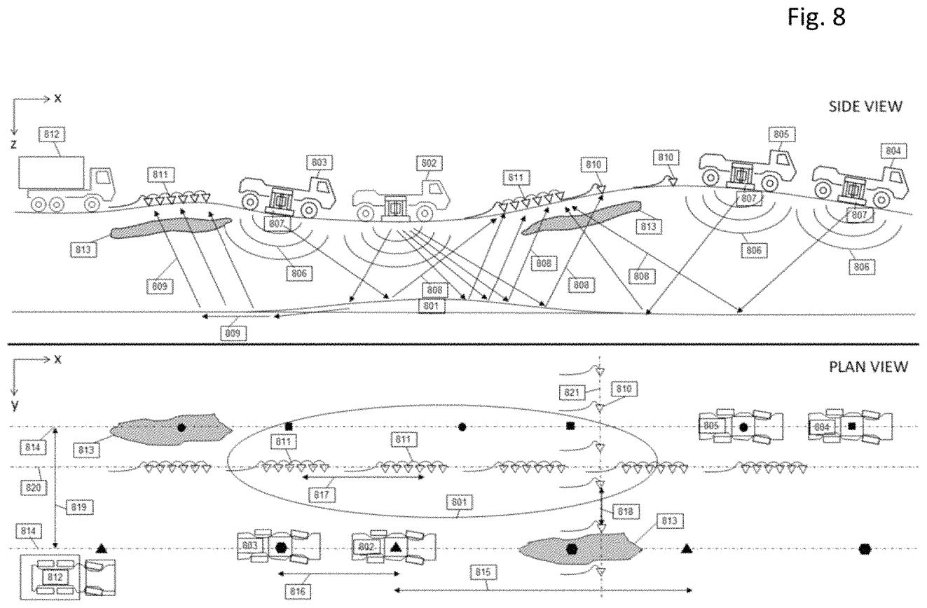

FIG. 5 shows the reference responses due to Source A and Source B separately as if the separation of the combined sources would have been perfect throughout the entire frequency band but now with a 10 Hz high cut filter applied. In contrast to FIG. 3, we can now see that the responses from Sources A and B are very similar as the sources are close to each other compared to the minimum wavelength in the spectrum (150 m at 10 Hz). The small time shift between the two sources (20 ms) is also present but small compared to frequency band in the graphs (10 Hz corresponds to a period of 100 ms).

Finally, in FIG. 6 we show the simultaneous source response of Source A and B (i.e. the data that would have been acquired before separation) as well as the response at the reference position Source C. In contrast to FIG. 4, we have applied at 10 Hz high cut filter to both graphs. In addition we have deconvolved the combined source signature from Sources A and B and reapplied a source signature without the 20 ms time shift. There is an excellent agreement between the simultaneous source response (Source A+B) and the response at the reference position in between.

The example illustrates how we can obtain the low frequency response of the seismic survey without an explicit source separation method that relies on encoding shots from shot point to shot point (e.g., using the method of signal apparition or the method of random dithers) for low frequencies. The low frequency response will correspond to the seismic response at the average location of the simultaneously firing sources (provided that the sources are closely located to each other compared to the minimum wavelength in the low frequency part of the frequency spectrum of interest). It will also be desirable to regularize the low frequency response in 2D (i.e. both inline and crossline source line locations) to reconstruct the response at the desired source locations and not just at average simultaneous source locations. This step is carried out using conventional methods for regularization well known to those skilled in the art.

Finally, the recovered low frequency part of the data illustrated in this example is added to the source separated response (e.g., using signal apparition or random dithers) of the remaining bandwidth of the data to yield the full bandwidth response of the separated sources.

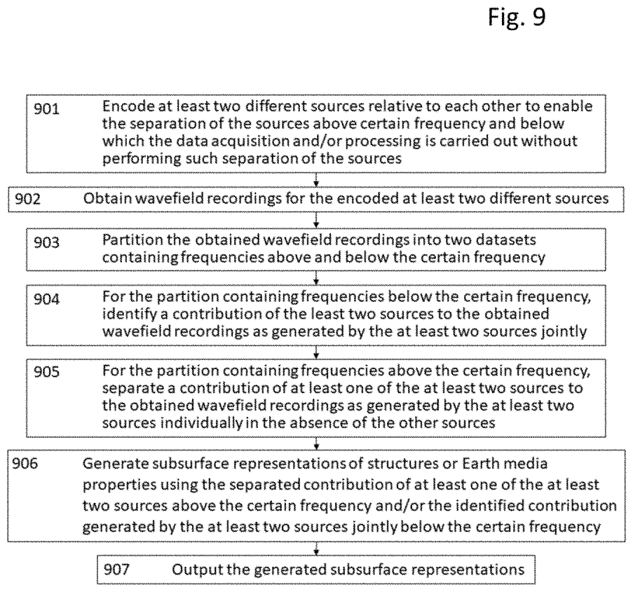

In FIG. 9, the key steps for one embodiment of the methods disclosed herein are summarized. In a first step, 901, At least two different sources are encoded relative to each other using the methods disclosed herein, enabling the separation of the sources above a certain frequency and below which the data acquisition and/or processing is carried out without performing such separation of the sources. In a second step, 902, wavefield recordings are obtained for the encoded at least two different sources in accordance with the general practice of marine or land seismic acquisition and the methods disclosed herein. In a third step, 903, the obtained wavefield recordings are partitioned into two datasets containing frequencies above and below the certain frequency. In a fourth step, 904, for the partition containing frequencies below the certain frequency, a contribution of the least two sources to the obtained wavefield recordings is identified as generated by the at least two sources jointly. In a fifth step, 905, for the partition containing frequencies above the certain frequency, a contribution of at least one of the at least two sources to the obtained wavefield recordings as generated by the at least two sources individually in the absence of the other sources is separated. In a sixth step, 906, Subsurface representations of structures or Earth media properties are generated using the separated contribution of at least one of the at least two sources above the certain frequency and/or the identified contribution generated by the at least two sources jointly below the certain frequency. In a seventh step, 907, the generated subsurface representations are output.

The methods described herein may be understood as a series of logical steps and (or grouped with) corresponding numerical calculations acting on suitable digital representations of the acquired seismic recordings, and hence can be implemented as computer programs or software comprising sequences of machine-readable instructions and compiled code, which, when executed on the computer produce the intended output in a suitable digital representation. More specifically, a computer program can comprise machine-readable instructions to perform the following tasks:

(1) Reading all or part of a suitable digital representation of the obtained wave field quantities into memory from a (local) storage medium (e.g., disk/tape), or from a (remote) network location;

(2) Repeatedly operating on the all or part of the digital representation of the obtained wave field quantities read into memory using a central processing unit (CPU), a (general purpose) graphical processing unit (GPU), or other suitable processor. As already mentioned, such operations may be of a logical nature or of an arithmetic (i.e., computational) nature. Typically the results of many intermediate operations are temporarily held in memory or, in case of memory intensive computations, stored on disk and used for subsequent operations; and

(3) Outputting all or part of a suitable digital representation of the results produced when there no further instructions to execute by transferring the results from memory to a (local) storage medium (e.g., disk/tape) or a (remote) network location.

Computer programs may run with or without user interaction, which takes place using input and output devices such as keyboards or a mouse and display. Users can influence the program execution based on intermediate results shown on the display or by entering suitable values for parameters that are required for the program execution. For example, in one embodiment, the user could be prompted to enter information about e.g., the average inline shot point interval or source spacing. Alternatively, such information could be extracted or computed from metadata that are routinely stored with the seismic data, including for example data stored in the so-called headers of each seismic trace.

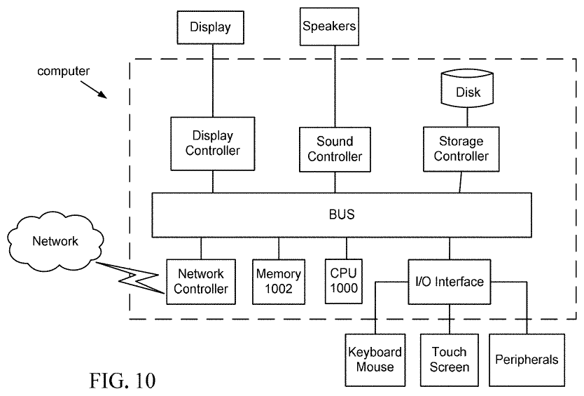

Next, a hardware description of a computer or computers used to perform the functionality of the above-described exemplary embodiments is described with reference to FIG. 10. In FIG. 10, the computer includes a CPU 1000 (an example of “processing circuitry”) that performs the processes described above. The process data and instructions may be stored in memory 1002. These processes and instructions may also be stored on a storage medium disk such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which computer communicates, such as a server or another computer.

Further, the claimed advancements may be provided as a utility application, background daemon, or component of an operating system, or combination thereof, executing in conjunction with CPU 1000 and an operating system such as Microsoft Windows 10, UNIX, Solaris, LINUX, Apple MAC-OS and other systems known to those skilled in the art.

The hardware elements in order to achieve the computer can be realized by various circuitry elements, known to those skilled in the art. For example, CPU 1000 can be a Xenon or Core processor from Intel of America or an Opteron processor from AMD of America, or may be other processor types that would be recognized by one of ordinary skill in the art (for example so-called GPUs or GPGPUs). Alternatively, the CPU 1000 can be implemented on an FPGA, ASIC, PLD or using discrete logic circuits, as one of ordinary skill in the art would recognize. Further, CPU 1000 may be implemented as multiple processors cooperatively working in parallel to perform the instructions of the inventive processes described above.

### List of Cited References

[Abma et al., 2012] Abma, R., Q. Zhang, A., Arogunmati, and G. Beaudoin, 2012, An overview of BP's marine Independent Simultaneous Source field trials: 82nd Annual International Meeting, SEG, Expanded Abstracts.

### [Abma et al., 2015] R. Abma, D. Howe, M. Foster, I. Ahmed, M. Tanis, Q. Zhang, A. Arogunmati and G. Alexander, Geophysics. 80, WD37 (2015).

[Akerberg et al., 2008] Akerberg, P., Hampson, G., Rickett, J., Martin, H., and Cole, J., 2008, Simultaneous source separation by sparse Radon transform: 78th Annual International Meeting, SEG, Expanded Abstracts, 2801-2805, doi:10.1190/1.3063927.
[Andersson et al., 2016] Andersson, F., Eggenberger, K., van Manen, D. J., Robertsson, J. O. A., and Amundsen, L., 2016, Seismic apparition dealiasing using directionality regularization: 2016 SEG annual meeting, Dallas.

### [Barnes, 1992] A. E. Barnes, GEOPHYSICS, 57(5), 749-751 (1992).

[Beasley et al., 1998] Beasley, C. J., Chambers, R. E., and Jiang, Z., 1998, A new look at simultaneous sources: 68th Annual International Meeting, SEG, Expanded Abstracts, 133-136.

### [Bracewell, 1999] R. Bracewell, The Fourier Transform & Its Applications (McGraw-Hill Science, 1999).

[Halliday et al., 2014] Halliday and Laws, Seismic acquisition using phase-shifted sweeps: US Patent application US20140278119A1 (2014).

### [Hager, 2016] Hager, E., 2016, Marine Seismic Data: Faster, Better, Cheaper?: GeoExpro, Vol. 13.

### [Ikelle, 2010] L. T. Ikelle, Coding and Decoding: Seismic Data: The Concept of Multishooting. (Elsevier, 2010), Vol. 39.

[Jiang and Abma, 2010] Jiang, Z. and R. Abma, 2010, An analysis on the simultaneous imaging of simultaneous source data: 80th Annual International Meeting, SEG, Expanded Abstracts.

### [Kumar et al., 2015] R. Kumar, H. Wason and F. J. Herrmann, Geophysics. 80, WD73 (2015).

[Landroe et al., 2011] Landroe, M, Amundsen, L., and Barker, D, 2011, High-frequency signals from air-gun arrays: GEOPHYSICS, 75 (4), Q19-Q27.
[Lynn et al., 1987] Lynn, W., Doyle, M., Larner, K., and Marschall, R., 1987, Experimental investigation of interference from other seismic crews: Geophysics, 52, 1501-1524.
[Moldoveanu et al., 2008] Moldoveanu, N., Kapoor, J., and Egan, M., 2008, Full-azimuth imaging using circular geometry acquisition: The Leading Edge, 27(7), 908-913. doi: 10.1190/1.2954032

### [Mueller et al., 2015] M. B. Mueller, D. F. Halliday, D. J. van Manen and J. O. A. Robertsson, Geophysics. 80, V133 (2015).

[Robertsson et al., 2012] Robertsson, J. O. A., Halliday, D., van Manen, D. J., Vasconcelos, I., Laws, R., Özdemir, K., and Gronaas, H., 2012, Full-wavefield, towed-marine seismic acquisition and applications: 74th Conference and Exhibition, EAGE, Extended Abstracts.
[Robertsson et al., 2015] Robertsson, J. O. A., R. M. Laws, and J. E. Kragh, 2015, Marine seismic methods, in Resources in the near-surface Earth (eds. L. Slater and D. Bercovici), Treatise on Geophysics, 2^{nd} edition (ed. G. Schubert), Elsevier-Pergamon, Oxford.
[Robertsson et al., 2016] Robertsson, J. O. A., Amundsen, L., and Pedersen, Å. S., 2016, Express Letter: Signal apparition for simultaneous source wavefield separation: Geophys. J. Int., 206(2), 1301-1305: doi: 10.1093/gji/ggw210.
[Shipilova et al., 2016] Shipilova, E., Barone, I., Boelle, J. L., Giboli, M., Piazza, J. L., Hugonnet, P., and Dupinet, C., 2016, Simultaneous-source seismic acquisitions: do they allow reservoir characterization? A feasibility study with blended onshore real data: 86th Annual International Meeting, SEG, Expanded Abstracts.
[Stefani et al., 2007] Stefani, J., Hampson, G., and Herkenhoff, E. F., 2007, Acquisition using simultaneous sources: 69th Annual International Conference and Exhibition, EAGE, Extended Abstracts, B006.
[Stockwell, 1996] R. G. Stockwell, L. Mansinha, and R. P. Lowe. Signal Processing, IEEE Transactions on 44(4), 998-1001 (1996).
[Ziolkowski, 1987] Ziolkowski, A. M., 1987, The determination of the far-field signature of an interacting array of marine seismic sources from near-field measurements: Results from the Delft Air Gun experiment: First Break, 5, 15-29.
[van Manen et al., 2016] van Manen, D. J., Andersson, F., Robertsson, J. O. A., and Eggenberger, K., 2016, Source separation method: GB Patent application No. 1603742.6 filed on 4 Mar. 2016.

1. A wavefield acquisition and/or processing method to separate sources above a certain frequency, below which the data acquisition and/or processing is performed without separating of the sources, the method comprising:
encoding at least two different sources relative to each other;
obtaining wavefield recordings for the encoded at least two sources;
partitioning the obtained wavefield recordings into a first dataset containing frequencies below the certain frequency, and a second dataset containing frequencies above the certain frequency;
for the first dataset containing frequencies below the certain frequency, identifying a first contribution of the least two sources to the obtained wavefield recordings as generated by the at least two sources jointly;
for the second data set containing frequencies above the certain frequency, separating a second contribution of at least one of the at least two sources to the obtained wavefield recordings as generated by the at least two sources individually in an absence of the other sources;
generating subsurface representations of structures or Earth media properties using the separated second contribution of at least one of the at least two sources above the certain frequency and the identified first contribution generated by the at least two sources jointly below the certain frequency; and
outputting the generated subsurface representations.

2. The method of claim 1, wherein the encoding step comprises encoding in the time domain.

3. The method of claim 1, wherein the encoding step comprises encoding in the spatial domain.

4. The method of claim 1, wherein the encoding step comprises encoding by changing firing times of the at least two sources relative to each other.

5. The method of claim 4, wherein the step of changing the firing times comprises changing the firing times relative to each other such that the at least two sources constructively interfere at and below the certain frequency.

6. The method of claim 1, wherein a lateral separation between the at least two sources is sufficiently small such that source locations are considered to belong to a same spatial location for wavelengths corresponding to and below the certain frequency.

7. The method of claim 4, wherein the firing times of the at least two sources occur within 80 ms.

8. The method of claim 6, wherein the lateral separation of the at least two sources is less than 150 m.

9. The method of claims 6, wherein the lateral separation of the at least two sources is less than 300 m.

10. The method of claim 1, wherein the certain frequency is lower than 6 Hz.

11. The method of claim 1, wherein a frequency band above the certain frequency is separated using a method of signal apparition.

12. The method of claim 1, wherein a frequency band above the certain frequency is separated using a method of random dithers.

13. The method of claim 11, wherein a frequency band below the certain frequency is processed using the method of signal apparition, but an average or sum of the at least two sources is obtained as opposed to the separation of the at least two sources.

14. The method of claim 13, wherein the frequency band below the certain frequency is not separated but considered to correspond to the average or sum of the at least two sources.

15. The method of claim 1, further comprising de-convolving an effective source signature for the at least two sources, from the frequency band below the certain frequency.

16. The method of claim 1, wherein spatial locations of the data corresponding to the frequency band below the certain frequency is associated with a mean lateral location between the at least two sources.

17. The method of claim 1, wherein data corresponding to the frequency band below the certain frequency are laterally spatially regularized to original shot locations.

18. The method of claim 1, further comprising combining data corresponding to the frequency band below the certain frequency with the separated data for the frequency band above the certain frequency to obtain full frequency response data sets for the at least two sources separately.

19. The method of claim 1, wherein the obtaining step comprises obtaining marine seismic data or seabed seismic data, wherein the at least two sources are towed by one or more vessels.

20. An apparatus to separate sources above a certain frequency, below which the sources are not separated, the apparatus comprising:
processing circuitry configured to
encode at least two different sources relative to each other;
obtain wavefield recordings for the encoded at least two sources;
partition the obtained wavefield recordings into a first dataset containing frequencies below the certain frequency, and a second dataset containing frequencies above the certain frequency;
for the first dataset containing frequencies below the certain frequency, identify a first contribution of the least two sources to the obtained wavefield recordings as generated by the at least two sources jointly;
for the second data set containing frequencies above the certain frequency, separate a second contribution of at least one of the at least two sources to the obtained wavefield recordings as generated by the at least two sources individually in an absence of the other sources;
generate subsurface representations of structures or Earth media properties using the separated second contribution of at least one of the at least two sources above the certain frequency and the identified first contribution generated by the at least two sources jointly below the certain frequency; and
output the generated subsurface representations.
